(19) United States
(12) Patent Application Publication
(10) Pub. No.: US 2017/0299745 A1
(43) Pub. Date: Oct. 19, 2017

(54) PRESTACK EGS MIGRATION METHOD FOR SEISMIC WAVE MULTI-COMPONENT DATA

(71) Applicant: Korea Institute of Geoscience and Mineral Resources, Daejeon (KR)

(72) Inventors: Byoung Yeop Kim, Daejeon (KR); Joong Moo Byun, Seoul (KR); Soon Jee Seol, Gyeonggi-do (KR); Ho Young Lee, Daejeon (KR)

(73) Assignee: Korea Institute of Geoscience and Mineral Resources, Daejeon (KR)

(21) Appl. No.: 15/508,957

(22) PCT Filed: Oct. 16, 2015
(86) PCT No.: PCT/KR2015/010951

§ 371 Date: Mar. 6, 2017

(30) Foreign Application Priority Data
Oct. 17, 2014 (KR) 10-2014-0140533

(51) Int. Cl. G01V 1/36; G01V 1/32; G01V 1/28

(52) U.S. Cl. CPC G01V 1/362; G01V 1/282; G01V 1/32; G01V 1/28; G01V 2210/512; G01V 2210/51

(57) ABSTRACT

The present invention relates to a one-way wave equation prestack depth migration method using an elastic generalized-screen (EGS) wave propagator capable of efficiently expressing the movement of an elastic wave passing through a mutual mode conversion between a P-wave and an S-wave while propagating boundary surfaces of an underground medium, by expanding, to an elastic wave equation, a conventional scalar generalized-screen (SGS) technique capable of quickly calculating the propagation of a wave in a medium in which there is a horizontal speed change, and according to the present invention, provided is a prestack EGS migration method for seismic wave multi-component data, which: can calculate a wave field with higher accuracy in a medium having a complex structure by expanding up to a second term of a Taylor series expansion of a vertical slowness term of a propagator; includes a mode separation operator in the propagator so as to directly use a shot gather as a migration input, without the need to separate multi-component data into a P-wave and an S-wave, enabling P-wave and S-wave image sections to be generated; and is configured to improve the quality of an S-wave migration image by correcting a polarity conversion in a wave number-frequency domain prior to S-wave imaging.

### TECHNICAL FIELD

The present invention relates to an elastic wave migration method, and more particularly, to a one-way wave equation prestack depth migration method using an elastic generalized-screen (EGS) wave propagator, which is capable of efficiently expressing the movement of an elastic wave passing through a mutual mode conversion between a P-wave and an S-wave while propagating through boundary surfaces of an underground medium, by expanding, to an elastic wave equation, a conventional scalar generalized-screen (SGS) technique capable of quickly calculating the propagation of a wave in a medium in which there is a horizontal speed change.

In addition, the present invention relates to a prestack EGS migration method for elastic wave multi-component data, which is capable of calculating with higher accuracy a wave field in a medium of a complex structure by expanding up to a second term of the Taylor series expansion of a vertical slowness term of a wave propagator.

In addition, the present invention relates to a prestack EGS migration method for elastic wave multi-component data, which is capable of generating sections of P-wave and S wave images by directly using a shot gather as a migration input without any needs to divide multi-component data into the P-wave and the S-wave, by including a mode separation operator into a propagator, differently from the related art using the input data after the multi-component data are first divided into P-wave and S-wave fields when the multi-component data are migrated.

In addition, the present invention relates to a prestack EGS migration method for elastic wave multi-component data, which is capable of improving the quality of an S-wave migration image by adding a module for correcting polarity conversion in a wavenumber-frequency domain before S-wave is imaged, in order to solve the problem of the related art that the continuity of events due to the phenomenon that the polarity of the S-wave shot gather is reversed at a reflection point when the S-wave shot gather of an elastic wave itself is used to correct the migration, so that the quality of a final section is deteriorated.

### BACKGROUND ART

In general, an elastic wave migration signifies the processes of transferring all first-order reflection events to the original positions, improving the spatial resolution by collapsing a diffraction curved line, and obtaining the image of an underground structure.

In this case, the correction position is determined by the travel time and velocity of the reflection wave. Such a migration method is mainly classified into Kirchhoff migration based on an integral solution of a wave equation, a migration using a finite difference method, and frequency-wavenumber migration using a frequency and a wavenumber.

In detail, first, the Kirchhoff migration is a method that calculates a suitable diffraction hyperbola having a vertex at each point on a stack section based on the ray theory and summates all sample values placed on the diffraction hyperbola to take the amplitude of a point corresponding to the migration section. The Kirchhoff migration has a fast calculation speed and represents a result with higher accuracy, so the Kirchhoff migration is widely used in the industrial field. However, in case of a complex structure, the ray theory may not be properly applied, so that the calculation may be failed.

In addition, in case of migration using a finite difference, reverse time migration using a full two-way wave equation is widely used. However, although this scheme has a merit of obtaining a result with higher accuracy even in a complex structure, the calculation time is too long.

In addition, as described above, the migration using a one-way wave equation, which is proposed to compensate for the defect of the Kirchhoff migration, in which imaging is failed in a complex structure, and the defect of the reverse time migration which causes long calculation time, is devised by considering only an up-going wave propagating in only one direction through approximation of the two-way wave equation, so that the migration is solved with finite difference in a time domain or is transferred to a frequency-wavenumber (F-K) domain to propagate a wave.

In this case, the one-way wave equation migration obtains the final migration section by using the one-way wave equation as a propagator of propagating a wave and applying the wave fields, which are generated from a source and a receiver to an imaging condition.

As described above, until now, the imaging of most elastic wave prospecting data has been performed based on a scalar wave equation.

In this case, although elastic wave data obtained by using a streamer in the sea or data obtained through a single-component geophone may be processed with such a wave equation, strictly speaking, an underground medium of the earth is not an acoustic medium such as water, but an elastic media having complex and heterogeneous characteristics.

That is, according to the related art, the data obtained from such an elastic medium are processed through a scalar wave equation or an acoustic wave equation, however, strictly speaking, this method is inaccurate because the elastic wave is regarded as the acoustic wave.

Thus, the elastic wave, which propagates through an elastic medium and comes back from the elastic medium, must be detected through a three-component geophone capable of detecting horizontal and vertical displacements (or velocity and acceleration) of the medium and the data must be processed by using the elastic wave equation.

In addition, in recent years, due to development of prospecting equipment and computing environment, many multi-component elastic wave prospecting data have been collected in an oil exploration market and migrations using an elastic wave equation have been widely performed.

That is, although the migration using an elastic wave equation is similar to the migration using such a scalar wave equation mentioned above, multi-component elastic wave data are used as an input wave field, and an elastic wave equation is used as a wave equation instead of an acoustic wave equation so that the mode conversion (from P wave to S wave or from S wave to P wave) occurring while the elastic wave propagates through a medium and the attenuation of a wave (that is, P-wave or S-wave) in each mode may be effectively expressed.

In more detail, as an example of the related art, Hokstad (2000) or Sun and McMechan (2011), etc., has expanded the Kirchhoff migration to the elastic field to apply the Kirchhoff migration to multi-component prospecting data. Chang and McMechan (1994) and Yan and Sava (2008) have developed reverse time migration by using an elastic wave equation (see reference documents 1 to 4).

However, similar to the scalar wave equation schemes, the elastic Kirchhoff scheme may still fail in imaging of a complex structure and the elastic reverse time migration has a disadvantage of a high calculation cost.

Thus, as a method for compensating for the disadvantages of the related art, there has been proposed an elastic one-way wave equation. That is, Landers and Claerbout (1972) have expanded a phase-screen scheme from an acoustic wave equation to an elastic wave equation for the first time, Fisk and McCartor (1991) have implemented the mode conversion of P-wave and S-wave through a one-way wave equation and Xie and Wu (2005) have developed a migration module by expanding the phase-screen scheme. However, they used P-wave and S-wave having a separate mode as an input wave field and any mode conversion was not considered in the migration modules (see reference documents 5 to 7).

In addition, Le Rousseau and De Hoop (2003) proposed an elastic generalized-screen (EGS) wave propagator by generalizing a split-step scheme and a phase-screen scheme, which are F-K migration, into an elastic wave (see reference document 8).

However, such methods approximate a vertical slowness operator only to the first order term and are stopped at a wave propagator development stage, so that development of such methods as the migration is not realized.

Therefore, to solve the problems of the related art described above, it is preferred to provide a new migration algorithm which is capable of improving the performance of an EGS wave propagator by correcting polarity inversion phenomenon of an S-wave through realizing more accurate wave propagation even in a complex model or in a model having a great horizontal speed change by expanding the EGS wave propagator of the related art, in which the vertical slowness term is only expanded to the first order, to the second order. However, an apparatus or a method satisfying such requirements has not been proposed yet.

### DOCUMENTS OF THE RELATED ART

1. Korean Registered Patent No. 10-1413751 (Jun. 24, 2014)
2. Korean Registered Patent No. 10-1219746 (Jan. 2, 2013)
3. Korean Registered Patent No. 10-1347969 (Dec. 27, 2013)
4. Korean Registered Patent No. 10-1281803 (Jun. 27, 2013)

### REFERENCE DOCUMENTS

1. Hokstad, K., 2000, Multicomponent Kirchhoff migration, Geophysics, 65, 861-873.
2. Sun R., and G. A. McMechan, 2011, Prestack 2D parsimonious Kirchhoff depth migration of elastic seismic data, Geophysics, 76, s157-s164.
3. Chang, W. F., and McMechan, G. A., 1994, 3-D elastic prestack reverse-time depth migration, Geophysics, 59, 579-609.
4. Yan J., and Sava P., 2008, Isotropic angle-domain elastic reverse-time migration, Geophysics, 77, 229-239.
5. Landers, T., and Claerbout, J. F., 1972, Numerical calculation of elastic waves in laterally inhomogeneous media, J. Geophys. Res., 77, 1476-1482.
6. Fisk, M. D., and McCartor, G. D., 1991, The phase screen method for vector elastic waves, J. Geophys. Res., 96, 5985-6010.
7. Xie X. B., and Wu, R. S., 2005, Multicomponent prestack depth migration using the elastic screen method, Geophysics, 70, 30-37.
8. Le Rousseau, J. H. and De Hoop M. V., 2003, Generalized-screen approximation and algorithm for the scattering of elastic waves, Q. JI Mech. Appl. Math., 56, 1-33.
9. Le Rousseau, J. H., 2001, Microlocal analysis of wave-equation imaging and generalized-screen propagators, Ph. D. Thesis, CWP, CSM.
10. Stoffa, P. L., Fokkema, J. T., De Luna F. R. M., and Kessinger, W. P., 1990, Split-step Fourier Migration, Geophysics, 55, 410-421.
11. Wu, R. S., and L. J. Huang, 1992, Scattered field calculation in heterogeneous media using phase-screen propagator, Expanded Abstracts of SEG 1992 Annual Meeting, 1289-1292.
12. De Hoop, M. V., 1996, Generalization of the Bremmer coupling series, J. Math. Phys., 37, 3246-3282.
13. De Hoop, M. V., and De Hoop, A. T., 1994, Elastic wave up/down decomposition in inhomogeneous and anisotropic media: an operator approach and its approximations, Wave Motion, 20, 57-82.
14. Sava P. C. and Fomel S., 2003, Angle-domain common-image gathers by wavefield continuation method, Geophysics, 68, 1065-1074.
15. Schleicher J., Costa J. C, and Novais A., 2008, A comparison of imaging condition for wave-equation shot-profile migration, Geophysics, 73, S219-S227.
16. Aminzadeh, F., J. Brae, and T. Kunz, 1997, SEG/EAGE 3-D salt and overthrust models, in SEG/EAGE 3-D Modeling Series, No. 1, SEG.

### DISCLOSURE

### Technical Problem

The present invention is proposed to solve the problems of related arts described above. To solve the problem of the EGS wave propagator according to the related art, in which the approximation of the vertical slowness operator is limited to the first order, an object of the present invention is to provide a prestack EGS migration method for elastic wave multi-component data, which is capable of more accurately implementing the propagation of a wave even in a model having a complex structure or a great horizontal speed change by expanding a vertical slowness term to the second order, so that the performance of the EGS wave propagator can be more improved.

In addition, to solve the problem of the migration method according to the related art, in which the calculation and structure are complex because the wave field is divided into the P-wave and S-wave and used as an input before migration, another object of the present invention is to provide a prestack EGS migration method for elastic wave multi-component data, which is capable of generating sections of P-wave and S wave images by directly using a shot gather as a migration input without any needs to divide an input multi-component wave field into the P-wave and the S-wave, by including a P-S separation module implemented in an EGS wave propagator.

In addition, to solve the problem of the related art, in which the continuity of events due to the phenomenon that the polarity of the S-wave shot gather is reversed at a reflection point when the S-wave shot gather of an elastic wave itself is used to correct the migration, so that the quality of a final section is deteriorated, still another object of the present invention is to provide a prestack EGS migration method for elastic wave multi-component data, which is capable of improving the quality of an S-wave migration image by adding a module for correcting polarity conversion in a wavenumber-frequency domain before S-wave is imaged.

### Technical Solution

To achieve the objects, in accordance with an aspect of the present invention, there is provided a prestack EGS migration method for elastic wave multi-component data, which expresses a movement of an elastic wave passing through a mutual mode conversion between a P-wave and an S-wave while propagating boundary surfaces of an underground medium, and generates sections of P-wave and S wave images by directly using a shot gather as a migration input without any needs to divide input data into the P-wave and the S-wave, by expanding a vertical slowness term of an elastic generalized-screen (EGS) wave propagator to a second order when multi-component data are migrated. The prestack EGS migration method includes: establishing a model for a source and a receiver after receiving elastic wave multi-component data to be analyzed and determining a frequency band to be calculated through Fourier transform; calculating a forward propagation from the source over each frequency band by using the EGS wave propagator; calculating a backward propagation from the receiver over each frequency band by using the EGS wave propagator; integrating the forward propagator with the backward propagator through cross correlation and migrating image data under an imaging condition; and outputting the migrated image data.

The EGS wave propagator is expressed as a following equation:

$$\int {dx}_{i}^{′} {dx}_{z}^{′} {g}_{asp}^{( 2 )} ( {x}_{μ} , x \text{?} \text{:} {x}_{2}^{′} , {x}_{3}^{′} - {Δx}_{3} ) ( \text{?} ) = \int {( \frac{s}{2 π} )}^{2} {dα}_{1}^{″} {dα}_{2}^{″} exp [ - {isa}_{σ}^{″} {x}_{σ} ] {M}^{0} ( {\overline{x}}_{3} , {α}_{v}^{″} ) exp ( ∓ s Δ {x}_{3} {π}^{2} ( {\overline{x}}_{3} , α {( \text{?} )}_{\text{?}} ) ] \times N \{ \int {dx}_{1}^{′} {dx}_{2}^{′} exp [ isa \text{?} x \text{?} ] {exp [ ∓ s Δ {x}_{3} π \text{?} ( {x}_{μ} , {\overline{x}}_{3} 0 ) ] [ {{M}^{0}}_{\text{?}} ]}^{- 1} ( {\overline{x}}_{3} , {{α}_{\text{?}}}_{v}^{″} \text{?} ) ( \cdot ) \times ( ∓ ) s Δ {x}_{3} {\sum }_{n} {\sum }_{λ} {\sum }_{i , j , k - 1}^{n} \{ ( {ϕ}_{ik} ) \text{?} ( {\overline{x}}_{μ} , α \text{?} ) - ( {ϕ}_{ik} ) \text{?} ( {\overline{x}}_{3} , 0 ) \} \times \int {dx}_{1}^{′} {dx}_{2}^{′} exp ( isa \text{?} x \text{?} ) exp {( ∓ s Δ {x}_{3} π \text{?} ( {ξ}_{ik} ) \text{?} ( {x}_{μ} , {\overline{x}}_{3} ) \vert {M}_{i , j}^{0} ]}^{- 1} ( {\overline{x}}_{3} , α \text{?} ) ( ′ ) j \} \\ \text{?} \text{indicates text missing or illegible when filed}$$

wherein x_{μ} (μ=1, 2) and x₃ represent horizontal and vertical coordinates, s=−iω (ω is an angular frequency), αᵥ=kᵥ/iω (kᵥ is a horizontal component wavenumber, v=1, 2), exp[−isα″_{σ}x_{σ}] and exp[isα″_{σ}x′_{σ}] are Fourier transform and Fourier inverse transform, M⁰ is a diversification matrix including an eigenvector and serves as an operator for coupling a P-wave and an S-wave separated from each other, [M⁰]⁻¹ is an inverse matrix of M⁰ and serves as an operator for separating the P-wave and the S-wave from each other, and λ is a number of terms.

The calculating of the forward propagation includes: separating a source wave field by a mode separation operator ([M⁰]⁻¹) in the EGS wave propagator; calculating a screen and a mode coupling in a frequency-space (f-x) domain; Fourier-transforming the screen and the mode coupling with a spatial variable (x); calculating an extrapolated wave field in a frequency-wavenumber (f-k) domain; storing each mode for the migration and recomposing the source wave field using a mode coupling operator (M⁰) in the EGS wave operator; and inversion-Fourier-transforming the recomposed source wave field.

The calculating of the backward propagation includes: separating a receiver wave field using a mode separation operator ([M⁰]⁻¹) in the EGS wave propagator; calculating the screen and the mode coupling in the frequency-space domain; Fourier-transforming the screen and the mode coupling calculated with the spatial variable (x); calculating the extrapolated wave field in the frequency-wavenumber domain (f-k); storing each mode for the migration and recomposing the receiver wave field using the mode coupling operator (M⁰) in the EGS wave operator; and inversion-Fourier-transforming the recomposed receiver wave field.

The calculating of the forward propagation and the calculating of the backward propagation are parallel processed by assigning a plurality of processors to process the calculation over frequency bands, thereby reducing a total processing time.

The migrating of the image data uses the imaging condition expressed as a following equation:

$${I}_{ij} ( {x}_{μ} , z ) = ( \pm ) \int \frac{i ω {\tilde{u}}_{S , i} ( {x}_{μ} , z ; ω ) {\tilde{u}}_{R , j} ⋆ ( {x}_{μ} , z ; ω )}{i ω {\tilde{u}}_{R , i} ( {x}_{μ} , z ; ω ) {\tilde{u}}_{R , j} ⋆ ( {x}_{μ} , z ; ω ) + ɛ} d ω$$

wherein Iᵢⱼ is a final image, [symbol] is a scalar source wave field in a Fourier domain, [symbol] is a scalar receiver wave field in the Fourier domain, ‘ε’ is expressed as ε(ω,z)=λ[max(|u_{R}(x_{μ},z;ω)|²)], ‘i’ and ‘j’ are vector wave fields of the source and the receiver and represent horizontal and vertical components (x and z) in multi-component elastic wave data.

The prestack EGS migration method further includes correcting an S-wave polarity inversion phenomenon that represents a change of a polarity at a reflection point of a medium boundary surface, by obtaining a reflection angle at the reflection point in the frequency-wavenumber domain by using a following equation:

$$tan γ = - \frac{{k}_{h}}{{k}_{z}}$$

Wherein γ represents a reflection angle at a reflection point, and kₕ and k_{z} represent a wavenumber in a distance direction and a wavenumber in a depth direction, respectively.

According to the present invention, there is provided a prestack EGS migration system for elastic wave multi-component data using the prestack EGS migration method for elastic wave multi-component data, wherein the prestack EGS migration system generates sections of P-wave and S wave images by directly using a shot gather as a migration input without any needs to divide an input multi-component wave field into the P-wave and the S-wave, and improves a quality of an S-wave migration image by correcting polarity conversion in a wavenumber-frequency domain before S-wave is imaged.

### Advantageous Effects

As described above, according to the present invention, there is provided a prestack EGS migration method for elastic wave multi-component data, which is capable of more accurately implementing the propagation of a wave even in a model having a complex structure or a great horizontal speed change by expanding a vertical slowness term to the second order, so that the performance of the EGS wave propagator may be more improved, thereby solving the problem of the EGS wave propagator according to the related art in which the approximation of the vertical slowness operator is limited to the first order.

In addition, according to the present invention, there is provided a prestack EGS migration method for elastic wave multi-component data, which is capable of generating sections of P-wave and S wave images by directly using a shot gather as a migration input without any needs to divide an input multi-component wave field into the P-wave and the S-wave, by including a P-S separation module implemented in an EGS wave propagator, thereby solving the problem of the migration method according to the related art, in which the calculation and structure are complex because the wave field is divided into the P-wave and S-wave and used as an input before migration.

In addition, according to the present invention, there is provided a prestack EGS migration method for elastic wave multi-component data, which is capable of improving the quality of an S-wave migration image by adding a module for correcting polarity conversion in a wavenumber-frequency domain before S-wave is imaged, thereby solving the problem of the related art in which the continuity of events due to the phenomenon that the polarity of the S-wave shot gather is reversed at a reflection point when the S-wave shot gather of an elastic wave itself is used to correct the migration so that the quality of a final section is deteriorated.

### DESCRIPTION OF DRAWINGS

FIG. 1 is a view illustrating the concept of an EGS wave propagator.

FIG. 2 is a view illustrating the wave field propagated through an EGS wave propagator in a zero-perturbation medium according to an embodiment of the present invention.

FIG. 3 is a view illustrating the wave field propagated through an EGS wave propagator in a perturbation medium according to an embodiment of the present invention.

FIG. 4 is a view illustrating a wave filed of each component propagating through an EGS wave propagator and wave fields divided into the P-wave and the S-wave by a mode separation operator in a simple two-layer horizontal model according to an embodiment of the present invention.

FIG. 5 is a view illustrating a concept of an EGS migration algorithm using an EGS wave propagator shown in FIG. 1.

FIG. 6 is a flowchart schematically illustrating the entire configuration of an EGS migration algorithm implemented based on the concept shown in FIG. 5 according to an embodiment of the present invention.

FIG. 7 is a flowchart schematically illustrating the entire configuration of a process for implementing MPI for a parallel processing of the EGS migration algorithm according to an embodiment of the present invention shown in FIG. 6.

FIG. 8 is a view showing the migration results obtained with and without a correction method of a polarity inversion by using an imaging condition of an EGS migration algorithm according to an embodiment of the present invention.

FIG. 9 is a view illustrating a P-wave speed configuration of a two-dimensional section model generated to verify an EGS migration algorithm according to an embodiment of the present invention.

FIG. 10 is a view illustrating images of final PP and PS sections obtained by applying an EGS migration method according to an embodiment of the present invention.

### BEST MODE

### Mode for Invention

Hereinafter, a prestack EGS migration method for elastic wave multi-component data according to exemplary embodiments of the present invention will be described in detail with reference to accompanying drawings.

The following description is only an example of the present invention and therefore it is to be noted that the present invention is not limited to contents of the following embodiments.

In the following description, it is to be noted that, when the functions of conventional elements and the detailed description of elements related with the present invention may make the gist of the present invention unclear, a detailed description thereof will be omitted.

That is, as will be described below, the present invention is proposed to solve the problem of the EGS wave propagator according to the related art in which the approximation of the vertical slowness operator is limited to the first order. The present invention relates to a prestack EGS migration method for elastic wave multi-component data, which is capable of more accurately implementing the propagation of a wave even in a model having a complex structure or a great horizontal speed change by extending a vertical slowness term to the second order, so that the performance of the EGS wave propagator may be more improved.

In addition, the present invention is proposed to solve the problem of the migration method according to the related art, in which the calculation and structure are complex because the wave field is divided into the P-wave and S-wave and used as an input before migration. The present invention relates to a prestack EGS migration method for elastic wave multi-component data, which is capable of generating sections of P-wave and S wave images by directly using a shot gather as a migration input without any needs to divide an input multi-component wave field into the P-wave and the S-wave, by including a P-S separation module implemented in an EGS wave propagator.

In addition, the present invention is proposed to solve the problem of the related art in which the continuity of events due to the phenomenon that the polarity of the S-wave shot gather is reversed at a reflection point when the S-wave shot gather of an elastic wave itself is used to correct the migration, so that the quality of a final section is deteriorated. The present invention relates to a prestack EGS migration method for elastic wave multi-component data, which is capable of improving the quality of an S-wave migration image by adding a module for correcting polarity conversion in a wavenumber-frequency domain before S-wave is imaged.

That is, in general, the propagator is an operator or a function such as an engine used when an elastic wave propagating through an earth model, which is numerically set, is numerically simulated. Thus, if the propagator is well implemented, the numerical model may represent well the propagation of an actual elastic wave through the earth.

As one example of the related art, the propagator proposed by Le Rousseau and De Hoop. 2003 (see reference document 8) is obtained by calculating a vertical slowness term (which is a function used when an actual wave propagates downwardly) to the first order. In other words, the propagator is an inaccurate propagator. That is, the propagator proposed in the document is only mathematically obtained and has not been implemented as migration algorithm yet.

Thus, the inventors of the present invention implement a migration algorithm by modifying the conventional wave propagator that calculates up to the first order and numerically improve the performance of the wave propagator by expanding the EGS wave propagator to the second order for more accurate wave propagation, thereby implementing a migration algorithm using the improved wave propagator, where the P-wave and S-wave are separated in the wave propagator and used for migration and a module for correcting the polarity inversion phenomenon of the S-wave is added to more improve the performance of the EGS wave propagator.

Hereinafter, the details of a prestack EGS migration method for elastic wave multi-component data according to the present invention will be described with reference to the drawings.

First describing an elastic thin-slab propagator before describing the details of the prestack EGS migration method for elastic wave multi-component data according to the present invention, Le Rousseau (2001, see reference document 9) has generalized a split-step Fourier method (Stoffa et al., 1990, reference document 10) and a phase-screen method (Wu and Huang, 1992, reference document 11) to allow the propagator, which is called a generalized-screen, to more exactly propagate in a medium in which the horizontal speed is greatly changed, and Le Rousseau and De Hoop (2003, see reference document 8) has expanded it to an elastic wave.

In more detail, if the properties of a medium are very small changed between two vertical depths [x′₃, x₃] and Δx₃ (=x₃−x′₃) is sufficiently small (thin slab), the elastic thin-slab propagator, which represents an up-going wave propagating upwardly and a down-going wave propagating downwardly between thin slabs, is expressed in a pseudo-differential operator (ΨDO) as following Equation 1.

$$\int {dx}_{1}^{′} {dx}_{2}^{′} {g}^{( 1 )} ( {x}_{μ} , {x}_{3} \text{?} {x}_{y}^{′} , x \text{?} ) ( \cdot ) ≅ \int {( \frac{λ}{2 π} )}^{2} {dα}_{1}^{″} {dα}_{2}^{″} exp [ - {isa}_{σ}^{′′} {x}_{σ} ] \times \int {dx}_{1}^{′} {dx}_{2}^{′} exp [ {isa}_{σ}^{″} {x}_{σ}^{′} ] exp [ - s {γ}^{( \pm )} ( x \text{?} , {\overline{x}}_{3} - \frac{1}{2} Δ {x}_{3} , {α}_{v}^{″} ) Δ {x}_{3} ] ( \text{?} ) \\ \text{?} \text{indicates text missing or illegible when filed} \qquad [ Equation 1 ]$$

Wherein x_{μ} (μ=1, 2) and x₃ represent horizontal and vertical coordinates, respectively, s=−iω (where ω is an angular frequency), and αᵥ=kᵥ/iω (where kᵥ is a horizontal component wavenumber, and v=1, 2).

In the pseudo-differential operator expressed as Equation 1, a spatial variable ‘x’ and Fourier variable ‘αᵥ’ are expressed in one term as an operator for extrapolating a wave field by moving a phase by using a vertical slowness term γ in a frequency-wavenumber domain.

In this case, exp[−isα″_{σ}x_{σ}] and exp[isα″_{σ}x′_{σ}] are kernels representing a Fourier transform and an inversion-Fourier transform.

In addition, in consideration of only the phase movement in a background medium, the vertical slowness term in the horizontal speed change existence medium is expressed in (γᵣ¹) in consideration of a vertical slowness term (γ⁰) and a horizontal speed change as following Equation 2.

γᵣ(x_{μ},ζ,αᵥ,s)=γ⁰(x₃,α)+γᵣ¹(x_{μ},ζ,αᵥ,s), where ζε[x′₃,x₃] [Equation 2]

In Equation 2, ‘γ’ represents a right symbol of a pseudo-differential operator.

That is, the separation of a spatial variable and a wavenumber variable of an elastic one-way thin slab wave propagator through approximation is a kernel of the elastic generalized-screen in consideration of the horizontal speed change.

Next, the generalized-screen propagator expanded to the second order of the vertical slowness term will be described below.

The right symbol of the vertical slowness operator (Γ), that is, γᵣ (see reference document 8 by Le Rousseau and De Hoop, 2003) is related with a characteristic operator ‘A’ expressed as following Equation 3.

Γ^{(±)}Γ^{(±)}=A [Equation 3]

In this case, when symbol aᵣ of ‘A’ is approximated only to the first order (high-frequency approximation: see reference document 12 by De Hoop, 1996), ‘A’ may be expressed as following Equation 4.

a_{r[2]}˜(aᵣ)_{[2]}^{[0]}+Σᵢ₌₁^{∞}(aᵣ)_{[2]}^{[i]} [Equation 4]

Wherein the subscript represents a symbol order and the superscript represents an order of medium contrast.

In addition, from Hooke's law and the symbol induction equation of the characteristic operator matrix ‘a’ of De Hoop and De Hoop in an isotropic medium, the principal symbol matrix (a[2]) may be calculated as following Equation 5.

a_{[2]11}=κ_{S}ρ+3α₁²−2κ_{P}κ_{S}⁻¹α₁²+α₂²,

a_{[2]12}=2α₁α₂κ_{S}⁻¹(κ_{S}−κ_{P}),

a_{[2]13}=2ρ^{1/2}κ_{S}^{-1/2}(κ_{P}−κ_{S})iα₁+4ρ^{-1/2}κ_{S}^{-1/2}(κ_{S}⁻¹κ_{P}−1)iα₁(α₁²+β₂²),

a_{[2]31}=ρ^{1/2}κ_{S}^{-1/2}(κ_{P}−κ_{S})iα₁,

a_{[2]33}=κ_{P}ρ+(2κ_{P}−κ_{S})κ_{S}⁻¹(α₁²+α₂²). [Equation 5]

Wherein α₂₂, α₁₂, α₁₃ and α₃₂ may be obtained by interchanging α₁ and α₂ between α₁₁, α₂₁, α₂₃ and α₃₁, kₛ⁻¹, kₛ^{-1/2}, ρ^{1/2} and ρ^{-1/2} are expanded by using the first to the third orders in Taylor series, and the results are replaced as the above equation and rearranged for ‘ε’ order, so that a symbol of a higher order may be obtained.

Thus, the background medium in the thin slab [x′₃, x₃], that is, the perturbation of (ρ⁰, κ_{P}⁰, κ_{S}⁰) may be expressed as following Equation 6.

κ_{P}(x_{μ},ζ)=κ_{P}⁰(x₃)[1+ε_{P}(x_{μ},ζ)],κ_{S}(x_{μ},ζ)=κ_{S}⁰(x₃)[1+ε_{S}(x_{μ},ζ)] and ρ(x_{μ},ζ)=ρ⁰(x₃)[1+ε_{P}(x_{μ},ζ)] for ζε[x′₃,x₃] [Equation 6]

In addition, when kₛ⁻¹, kₛ^{-1/2}, ρ^{1/2} [symbol] ρ^{-1/2} in the principal symbol matrix a[2] are expanded in Taylor series and are applied to Equation 5 together with Equation 6, principal symbol ‘a’ for the medium contrast expanded to the second order term may be obtained as following Equations 7 to 9.

That is, the following Equation 7 represents terms independent from ‘ε’ in the Equation 5, so that they include a background term of the propagator.

In addition, α_{γ,22}, α_{γ,12}, α_{γ,13} and α_{γ,32} in the Equation 7 may be obtained by interchanging α₁ and α₂ with α_{γ,11}, α_{γ,21}, α_{γ,23} and α_{γ,31}, respectively.

$$\begin{matrix}{{α}_{γ}}_{[ 2 ] 11}^{[ 0 ]} = 3 {α}_{1}^{2} + {α}_{2}^{2} - 2 {{{α}_{1}^{2} [ {v}_{S}^{0} ]}^{2} [ {v}_{P}^{0} ]}^{- 2} + {[ {v}_{S}^{0} ]}^{- 2} , \\ {{α}_{γ}}_{[ 2 ] 12}^{[ 0 ]} = 2 {α}_{1} {{{α}_{2} [ {v}_{PS}^{0} ]}^{- 2} [ {v}_{S}^{0} ]}^{2} , \\ {{α}_{γ}}_{[ 2 ] 13}^{[ 0 ]} = - {2 [ {v}_{PS}^{0} ]}^{- 2} {v}_{S}^{0} i {α}_{1} - {{4 [ {v}_{PS}^{0} ]}^{- 2} [ {v}_{S}^{0} ]}^{3} i {α}_{1} ( {α}_{1}^{2} + {α}_{2}^{2} ) , \\ {{α}_{γ}}_{[ 2 ] 31}^{[ 0 ]} = - {[ {v}_{PS}^{0} ]}^{- 2} {v}_{S}^{0} i {α}_{1} , \\ {{α}_{γ}}_{[ 2 ] 33}^{[ 0 ]} = {[ {v}_{P}^{0} ]}^{- 2} + {( {α}_{1}^{2} + {α}_{2}^{2} ) [ {v}_{S}^{0} ]}^{2} ( {2 [ {v}_{P}^{0} ]}^{- 2} - {[ {v}_{S}^{0} ]}^{- 2} ) , . {[ {v}_{PS}^{0} ]}^{- 2} = {[ {v}_{S}^{0} ]}^{- 2} - {[ {v}_{P}^{0} ]}^{- 2} & [ Equation 7 ] \\ {{α}_{γ}}_{[ 2 ] 11}^{[ 1 ]} = - {{2 [ {v}_{P}^{0} ]}^{- 2} [ {v}_{S}^{0} ]}^{2} {α}_{1}^{2} {ε}_{p} + \{ {[ {v}_{S}^{0} ]}^{- 2} + {2 [ {v}_{P}^{0} ]}^{- 2} + {2 [ {v}_{S}^{0} ]}^{2} {α}_{1}^{2} ) {ε}_{S} + {[ {v}_{S}^{0} ]}^{- 2} {ε}_{P} , \\ {{α}_{γ}}_{[ 2 ] 12}^{[ 1 ]} = - {{2 [ {v}_{P}^{0} ]}^{- 2} [ {v}_{S}^{0} ]}^{2} {α}_{1} {α}_{2} ( {ε}_{P} - {ε}_{S} ) , \\ {{α}_{γ}}_{[ 2 ] 13}^{[ 1 ]} = ( {{4 [ {v}_{P}^{0} ]}^{- 2} [ {v}_{S}^{0} ]}^{3} i {α}_{1} ( {α}_{1}^{2} + {α}_{2}^{2} ) + {2 [ {v}_{P}^{0} ]}^{- 2} {v}_{S}^{0} i {α}_{1} ) {ε}_{P} + ( 2 {( {[ {v}_{S}^{0} ]}^{- 2} - {3 [ {v}_{P}^{0} ]}^{- 2} ) [ {v}_{S}^{0} ]}^{3} i {α}_{1} ( {α}_{1}^{2} + {α}_{2}^{2} ) - {[ {v}_{P}^{0} ]}^{- 1} i {α}_{1} - {[ {v}_{P}^{0} ]}^{- 2} {v}_{s}^{0} i {α}_{1} ) {ε}_{S} + {{2 [ {v}_{PS}^{0} ]}^{- 2} [ {v}_{S}^{0} ]}^{3} i {α}_{1} ( {α}_{1}^{2} + {α}_{2}^{2} ) + {[ {v}_{P}^{0} ]}^{- 2} {v}_{S}^{0} i {α}_{1} - {[ {v}_{S}^{0} ]}^{- 1} i {α}_{1} ) {ε}_{p} \\ {{α}_{γ}}_{[ 2 ] 31}^{[ 1 ]} = - \frac{1}{2} ( {[ {v}_{P}^{0} ]}^{- 2} {v}_{S}^{0} - {[ {v}_{S}^{0} ]}^{- 1} ) i {α}_{1} {v}_{s} + {[ {v}_{P}^{0} ]}^{- 2} {v}_{S}^{0} i {α}_{1} {ε}_{p} - {\frac{1}{2} [ {v}_{PS}^{0} ]}^{- 2} {v}_{S}^{0} i {α}_{1} {ε}_{p} , \\ {{α}_{γ}}_{[ 2 ] 33}^{[ 1 ]} = {[ {v}_{P}^{0} ]}^{- 2} ( {ε}_{p} + {ε}_{p} ) + {{2 [ {v}_{P}^{0} ]}^{- 2} [ {v}_{S}^{0} ]}^{2} ( {α}_{1}^{2} + {α}_{2}^{2} ) ( {ε}_{P} - {ε}_{S} ) . & [ Equation 8 ] \\ {{α}_{γ}}_{[ 2 ] 11}^{[ 2 ]} = - {{2 [ {v}_{P}^{0} ]}^{- 2} [ {v}_{S}^{0} ]}^{2} {α}_{1}^{2} {ε}_{S} ( {ε}_{P} - {ε}_{S} ) + {[ {v}_{S}^{0} ]}^{- 2} + {ε}_{S} {ε}_{P ,} \\ {{α}_{γ}}_{[ 2 ] 12}^{[ 2 ]} = {{2 [ {v}_{P}^{0} ]}^{- 2} [ {v}_{S}^{0} ]}^{2} {α}_{1} {α}_{2} {θ}_{x} ( {ε}_{P} - {ε}_{S} ) , \\ {{α}_{γ}}_{[ 2 ] 13}^{[ 2 ]} = \frac{1}{4} ( {3 [ {v}_{P}^{0} ]}^{- 2} + {[ {v}_{S}^{0} ]}^{2} ) {v}_{S}^{0} i {α}_{1} {θ}_{3}^{2} + \frac{1}{2} ( {15 [ {v}_{P}^{0} ]}^{- 2} - {{3 [ {v}_{S}^{0} ]}^{- 1} [ {v}_{S}^{0} ]}^{2} i {α}_{1} ( {α}_{1}^{2} + {α}_{2}^{2} ) {ε}_{S}^{2} - \frac{1}{2} ( {( {[ {v}_{P}^{0} ]}^{- 2} + {[ {v}_{S}^{0} ]}^{- 2} ) [ {v}_{S}^{0} ]}^{3} i {α}_{1} ( {α}_{1}^{2} + {α}_{2}^{2} ) - {ε}_{S} {ε}_{P} - {[ {v}_{P}^{0} ]}^{- 2} ( {v}_{S}^{0} i {α}_{1} + {6 [ {v}_{S}^{0} ]}^{3} i {α}_{1} ( {α}_{1}^{2} + {α}_{2}^{2} ) ) {ε}_{p}^{2} + {[ {v}_{PS}^{0} ]}^{- 2} ( \frac{1}{4} {v}_{s}^{0} i {α}_{1} - {\frac{3}{2} [ {v}_{S}^{0} ]}^{3} i {α}_{1} ( {a}_{1}^{2} + {α}_{2}^{2} ) ) {ε}_{P}^{2} + {[ {v}_{P}^{0} ]}^{- 2} ( {v}_{S}^{0} i {a}_{1} - {2 [ {v}_{S}^{0} ]}^{3} i {α}_{1} ( {α}_{1}^{2} + {α}_{2}^{2} ) ) {ε}_{P} {s}_{p} \\ {{α}_{γ}}_{[ 2 ] 31}^{[ 2 ]} = \frac{1}{2} ( {[ {v}_{P}^{0} ]}^{- 2} {v}_{S}^{0} i {α}_{1} {ε}_{P} ( {ε}_{p} - {ε}_{S} ) + ( {\frac{1}{8} [ {v}_{S}^{0} ]}^{- 2} + {\frac{3}{8} [ {v}_{P}^{0} ]}^{- 2} ) {v}_{S}^{0} i {α}_{1} {ε}_{S}^{2} - \frac{1}{4} ( {[ {v}_{S}^{0} ]}^{- 2} + {[ {v}_{P}^{0} ]}^{- 2} ) {v}_{S}^{0} i {α}_{1} {ε}_{S} {ε}_{P} + {\frac{1}{8} [ {v}_{PS}^{S} ]}^{- 2} {v}_{S}^{0} i {α}_{1} {ε}_{P}^{2} \\ {{α}_{γ}}_{[ 2 ] 33}^{[ 2 ]} = {[ {v}_{P}^{0} ]}^{- 2} ( {ε}_{p} + {ε}_{p} ) + {{2 [ {v}_{P}^{0} ]}^{- 2} [ {v}_{S}^{0} ]}^{2} ( {α}_{1}^{2} + {α}_{2}^{2} ) {ε}_{S} ( {ε}_{S} - {ε}_{P} ) . & [ Equation 9 ]\end{matrix}$$

Wherein Equation 8 is obtained by rearranging Equation 5 with the first epsilon order term after Taylor expanding Equation 5 and Equation 9 is obtained by rearranging Equation 5 with the second epsilon order term after Taylor expanding Equation 5. In this case, specific terms are obtained by correcting an error of a part of Le Rousseau's deviation.

Therefore, the expansion of the vertical slowness term γᵣ¹ from principal symbol ‘a’ to the second order term may be calculated through the recursive relationship between a_{[2]} and γᵣ¹ of Le Rousseau's (2001) expressed as Equations 7 to 9 and following Equation 10.

(γ⁰)²=a_{[2]}^{[0]},

γ⁰η_{[1]}^{[1]}+η_{[1]}^{[1]}γ⁰=a_{[2]}^{[1]},

(η_{[1]}^{[1]})²+γ⁰η_{[1]}^{[2]}+η_{[1]}^{[2]}γ⁰=a_{[2]}^{[1]} [Equation 10]

Wherein η_{[1]}^{[1]} represents a frequency approximation of perturbation or a 3×3 matrix which is a principle part.

γ⁰ and γᵣ¹ may be expressed by multiplication of diagonalizing matrix M⁰ and inversion matrix [M⁰]⁻¹ thereof as following Equation 11.

γ⁰=M⁰π⁰[M⁰]⁻¹,

γᵣ¹=M⁰πᵣ¹[M⁰]⁻¹=Σₙη_{[1]}^{[1]} [Equation 11]

Wherein

$${π}^{0} = diag . ( \sqrt{{[ {v}_{S}^{0} ]}^{- 2} + {α}_{v} {α}_{v}} , \sqrt{{[ {v}_{S}^{0} ]}^{- 2} + {α}_{v} {α}_{v}} , \sqrt{{[ {v}_{P}^{0} ]}^{- 2} + {α}_{v} {α}_{v}} ) ,$$

ν_{S}⁰ and ν_{P}⁰ are background velocities, diagonalizing matrix M⁰ is a matrix including an eigenvector (De Hoop and De Hoop, 1994, reference document 13), and inversion matrix [M⁰]⁻¹ thereof is operated as an operator for separating the P-wave and the S-wave from the background medium just before the thin slab propagates.

That is, M⁰ couples the P-wave and the S-wave to each other just before the thin slab propagates.

In addition, η_{[1]}^{[n]} is expressed in an eigenvector form as following Equation 12.

η_{[1]}^{[n]}=M⁰θ_{[1]}^{[n]}[M⁰]⁻¹ [Equation 12]

Following Equation 13 is obtained from Equation 11 and Equation 12.

πᵣ¹=Σₙθ_{[1]}^{[n]} [Equation 13]

Thus, if θ_{[1]}^{[n]} is obtained, γᵣ¹ may be obtained from πᵣ¹.

That is, when Equation 11 and Equation 12 are applied to Equation 10 and a_{[2]}^{[1]} of Equation 8 is used, θ_{[1]}^{[1]} which is the first expansion of θ_{[1]}^{[n]} may be obtained as following Equation 14.

Likewise, θ_{[1]}^{[2]} which is the second expansion of θ_{[1]}^{[n]} may be calculated by applying Equation 11 and Equation 12 to Equation 10 and using a_{[2]}^{[2]} of Equation 9 as following Equation 15.

$${ϑ}_{[ 1 ] 11}^{[ 1 ]} = \frac{{[ {v}_{S}^{0} ]}^{- 2}}{2 {π}_{11}^{0}} ( {ε}_{S} + {ε}_{ρ} ) \\ {ϑ}_{[ 1 ] 22}^{[ 1 ]} = \frac{{[ {v}_{S}^{0} ]}^{- 2}}{2 {π}_{22}^{0}} ( {ε}_{S} + {ε}_{ρ} ) \\ {ϑ}_{[ 1 ] 33}^{[ 1 ]} = \frac{{[ {v}_{P}^{0} ]}^{- 2}}{2 {π}_{33}^{0}} ( {ε}_{P} + {ε}_{ρ} ) \\ {ϑ}_{[ 1 ] 13}^{[ 1 ]} = - \frac{{[ {v}_{PS}^{0} ]}^{- 2} {v}_{S}^{0} \sqrt{{α}_{v} {α}_{v}}}{{π}_{11}^{0} + {π}_{33}^{0}} ( {ε}_{S} + {ε}_{ρ} ) \\ {ϑ}_{[ 1 ] 31}^{[ 1 ]} = \frac{{[ {v}_{PS}^{0} ]}^{- 2} {v}_{S}^{0} \sqrt{{α}_{v} {α}_{v}} ( 1 - {2 [ {v}_{S}^{0} ]}^{2} ( {α}_{v} {α}_{v} ) )}{2 ( {π}_{11}^{0} + {π}_{33}^{0} )} ( {ε}_{S} + {ε}_{ρ} ) \qquad [ Equation 14 ]$$

Wherein remaining components are 0 (zero).

$${ϑ}_{[ 1 ] 11}^{[ 2 ]} = - \frac{1}{2 {π}_{11}^{0}} [ \frac{{[ {v}_{S}^{0} ]}^{- 1} {( {ε}_{S} + {ε}_{ρ} )}^{2}}{{4 [ {π}_{11}^{0} ]}^{2}} - {[ {v}_{S}^{0} ]}^{- 2} {ε}_{S} {ε}_{ρ} + ( {[ {v}_{S}^{0} ]}^{2} - {[ {v}_{P}^{0} ]}^{2} ) ( {α}_{v} {α}_{v} ) \times ( 1 - {2 [ {v}_{S}^{0} ]}^{2} ( {α}_{v} {α}_{v} ) ) \frac{{[ {v}_{P}^{0} ]}^{- 2}}{2} ( 1 + \frac{{[ {v}_{PS}^{0} ]}^{- 2}}{{( {π}_{11}^{0} + {π}_{33}^{0} )}^{2}} ) {( {ε}_{S} + {ε}_{ρ} )}^{2} ] \\ {ϑ}_{[ 1 ] 22}^{[ 2 ]} = - \frac{1}{2 {π}_{22}^{0}} [ \frac{{[ {v}_{S}^{0} ]}^{- 1} {( {ε}_{S} + {ε}_{ρ} )}^{2}}{{4 [ {π}_{22}^{0} ]}^{2}} - {[ {v}_{S}^{0} ]}^{- 2} {ε}_{S} {ε}_{ρ} ] \\ {ϑ}_{[ 1 ] 33}^{[ 2 ]} = - \frac{1}{2 {π}_{33}^{0}} [ \frac{{[ {v}_{P}^{0} ]}^{- 1} {( {ε}_{P} {ε}_{ρ} )}^{2}}{{4 [ {π}_{33}^{0} ]}^{2}} - {[ {v}_{P}^{0} ]}^{- 2} {ε}_{P} {ε}_{ρ} + ( {[ {v}_{S}^{0} ]}^{2} - {[ {v}_{P}^{0} ]}^{2} ) ( {α}_{v} {α}_{v} ) \times ( 1 - {2 [ {v}_{S}^{0} ]}^{2} ( {α}_{v} {α}_{v} ) ) \frac{{[ {v}_{P}^{0} ]}^{- 2}}{2} ( - 1 + \frac{{[ {v}_{PS}^{0} ]}^{- 2}}{{( {π}_{11}^{0} + {π}_{33}^{0} )}^{2}} ) {( {ε}_{S} + {ε}_{ρ} )}^{2} ] \\ {ϑ}_{[ 1 ] 12}^{[ 2 ]} = \frac{\sqrt{{α}_{v} {α}_{v}}}{{π}_{11}^{0} + {π}_{22}^{0}} [ {[ {v}_{P}^{0} ]}^{- 2} {v}_{S}^{0} ( {ε}_{S} {ε}_{P} - {ε}_{S}^{2} + {ε}_{P} {ε}_{ρ} ) - { [ {v}_{S}^{0} ]}^{- 1} {ε}_{S} {ε}_{ρ} - {{v}_{S}^{0} [ {v}_{PS}^{0} ]}^{- 2} ( 1 - {4 [ {v}_{S}^{0} ]}^{2} ( {α}_{v} {α}_{v} ) ) {( \frac{{ε}_{S} + {ε}_{ρ}}{2} )}^{2} + \frac{{{v}_{S}^{0} [ {v}_{PS}^{0} ]}^{- 1}}{2 ( {π}_{11}^{0} + {π}_{33}^{0} )} ( \frac{{[ {v}_{P}^{0} ]}^{- 2}}{{π}_{33}^{0}} ( {ε}_{S} + {ε}_{ρ} ) ( {ε}_{P} + {ε}_{ρ} ) + \frac{{[ {v}_{S}^{0} ]}^{- 2}}{{π}_{11}^{0}} {( {ε}_{S} + {ε}_{ρ} )}^{2} ) ] \\ {ϑ}_{[ 1 ] 31}^{[ 2 ]} = \frac{\sqrt{{α}_{v} {α}_{v}}}{{π}_{11}^{0} + {π}_{23}^{0}} [ {\frac{1}{2} [ {v}_{P}^{0} ]}^{- 2} {v}_{S}^{0} ( - 1 + {2 [ {v}_{S}^{0} ]}^{2} ( {α}_{v} {α}_{v} ) ) {ε}_{S} {ε}_{P} + \frac{1}{8} {{v}_{S}^{0} [ {v}_{PS}^{0} ]}^{- 2} ( 1 + {6 [ {v}_{S}^{0} ]}^{2} ( {α}_{v} {α}_{v} ) - {8 [ {v}_{S}^{0} ]}^{4} {( {α}_{v} {α}_{v} )}^{2} ) {( {ε}_{S} + {ε}_{ρ} )}^{2} + \frac{1}{2} ( 1 - {2 [ {v}_{S}^{0} ]}^{2} ( {α}_{v} {α}_{v} ) ) ( {[ {v}_{P}^{0} ]}^{- 2} {v}_{S}^{0} ( {ε}_{S}^{0} - {ε}_{P} {ε}_{ρ} ) + {[ {v}_{S}^{0} ]}^{- 1} {ɛ}_{S} {ɛ}_{ρ} ) - \frac{{{v}_{S}^{0} [ {v}_{PS}^{0} ]}^{- 2} ( 1 - {2 [ {v}_{S}^{0} ]}^{2} ( {α}_{v} {α}_{v} ) )}{4 ( {π}_{11}^{0} + {π}_{33}^{0} )} ( \frac{{[ {v}_{P}^{0} ]}^{- 2}}{{π}_{33}^{0}} ( {ε}_{S} + {ε}_{ρ} ) ( {ε}_{P} + {ε}_{ρ} ) + \frac{{[ {v}_{S}^{0} ]}^{- 2}}{{π}_{11}^{0}} {( {ε}_{S} + {ε}_{ρ} )}^{2} ) ] \qquad [ Equation 15 ]$$

Wherein remaining components are 0 (zero).

The diagonal entries of matrix θ_{[1]}^{[n]} participate in the propagations of the P-wave and the S-wave, and off-diagonal entries participate in a mode coupling. If spatial variable ‘ε’ is not separated in Fourier domain, there is difficulty to do Fourier transform between space and wavenumber domains at all calculation nodes.

However, in the case of an EGS wave propagator, since the EGS wave propagator is calculated while a spatial variable is effectively separated in Fourier domain, Fourier transforms are performed as many as the number of not nodes but expansion terms, so that the calculations concerning the wave propagation may be rapidly performed.

As described above, to effectively separate the spatial variable from the frequency-wavenumber domain, θ_{[1]}^{[n]} may be expanded in the multiplication of phase term αᵥ and spatial variable x_{μ} as following Equation 16 (see reference document 9 by Le Rousseau, 2001).

θ_{[1]ij}^{[n]}(x′_{μ},αᵥ)=Σ_{λ}ξ_{[1]ij}^{[n]λ}(x′_{μ})φ_{[1]ij}^{[n]λ}(α′ᵥ) [Equation 16]

Wherein λ is the number of terms in Equation 14 and Equation 15.

Thus, when Equation 11 to Equation 13 and Equation 16 are applied to Equation 1 and Equation 2, a final EGS wave propagator may be obtained as following Equation 17.

$$\int {dx}_{1}^{′} {dx}_{2}^{′} {g}_{OSP}^{( \pm )} ( {x}_{μ} , {x}_{3} \text{:} {x}_{y}^{′} , {x}_{3}^{′} - Δ {x}_{3} ) ( \text{?} ) = \int {( \frac{s}{2 π} )}^{2} d {α}_{1}^{″} d {α}_{2}^{″} exp [ - {isa}_{σ}^{″} {x}_{σ} ] {M}^{0} ( {\overline{x}}_{3} , {α}_{v}^{″} ) exp [ ∓ s Δ {x}_{3} {π}^{0} ( {\overline{x}}_{3} , {α}_{v}^{″} ] \times N \{ \int {dx}_{1}^{′} {dx}_{2}^{′} exp [ {isa}_{σ}^{″} {x}_{σ}^{′} ] exp [ ∓ s Δ {x}_{3} π \text{?} {( {x}_{μ}^{′} , {\overline{x}}_{3} , 0 ) ] [ {M}^{0} ]}^{- 1} ( {\overline{x}}_{3} , {α}_{v}^{″} \} ) ( \text{?} ) \times ( ∓ ) s Δ {x}_{3} {\sum }_{n} {\sum }_{λ} {\sum }_{i , j , k = 1}^{n} ( ( {ϕ}_{ik} ) \text{?} ( {\overline{x}}_{3} , {α}_{v}^{″} ) - ( {ϕ}_{ik} ) \text{?} ( {\overline{x}}_{3} , 0 ) \} \times \int {dx}_{1}^{′} {dx}_{2}^{′} exp [ {isa}_{σ}^{″} {x}_{σ}^{′} ] exp [ ∓ s Δ {x}_{3} {π}_{r}^{1} ( {x}_{μ}^{′} , {α}_{v}^{″} ) - ( {ϕ}_{ik} ) \text{?} ( {\overline{x}}_{3} , 0 ) ] ( {ξ}_{ik} ) \text{?} {( {x}_{μ} , {\overline{x}}_{3} ) [ {M}_{kj}^{0} ]}^{- 1} ( {\overline{x}}_{3} , {α}_{v}^{″} ) \text{?} \\ \text{?} \text{indicates text missing or illegible when filed} \qquad [ Equation 17 ]$$

ξ_{[1]ij}^{n,λ}(x′_{μ}) is a screen term and calculated in a frequency-space (f-x) domain, and φ_{[1]ij}^{n,λ}(α′ᵥ) is a phase-shift term and calculated in a frequency-wavenumber (f-k) domain.

In addition, ‘N’ is a normalizing operator and is used to prevent energy from inexactly being amplified or attenuated according to a wavenumber or a propagation angle due to a truncation error in infinite series expansion (see reference document 8 by Le Rousseau and De Hoop, 2003).

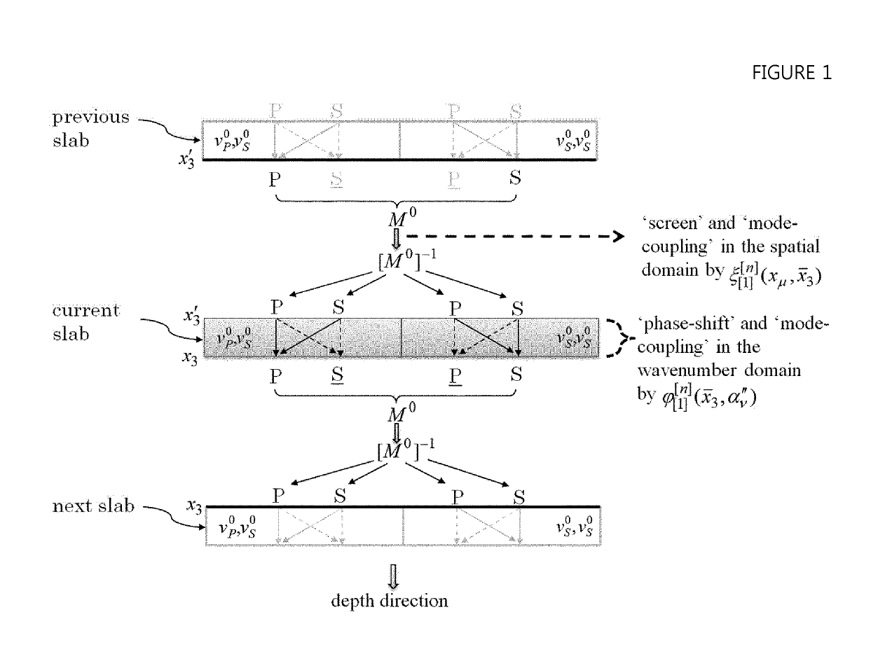

That is, referring to FIG. 1, FIG. 1 is a view illustrating the concept of an EGS wave propagator. FIG. 1 is a view conceptually illustrating the calculation of Equation 17.

That is, as shown in FIG. 1, the wave field divided into P-wave and S-wave propagates into two background mediums (thin slabs including a medium in which the velocities of P-wave and S-wave are ν_{P}⁰, ν_{S}⁰ and a medium in which the velocities of P-wave and S-wave are ν_{S}⁰, ν_{S}⁰).

In the case of the second medium [ν_{S}⁰, ν_{S}⁰] through which S-wave propagates, the reason why the background speed of P-wave is not ν_{P}⁰ but ν_{S}⁰, is because the speed of S-wave is lower than the background speed of P-wave so that a branch point may be generated.

That is, in FIG. 1, the P-wave propagates into the medium having background speed [ν_{P}⁰, ν_{S}⁰], and the S-wave (S in the drawings) generated in this case contributes to the mode conversion and is not used in an actual following thin slab.

Likewise, the S-wave propagates into the medium having background speed [ν_{S}⁰, ν_{S}⁰], and the P-wave P generated in this case contributes to the mode conversion and is not used in an actual following thin slab.

The P-wave propagating through the medium having background speed [ν_{P}⁰, ν_{S}⁰] and the S-wave propagating through the medium having background speed [ν_{S}⁰, ν_{S}⁰] are the P-wave and S-wave propagating through an actual following slab.

In addition, as described above, the wave filed of the P-wave and S-wave passing through a thin slab becomes the original wave field (Vx, Vz) by adding two modes by M⁰ and the screen term is calculated by ξ_{[1]ij}^{n,λ}(x′_{μ}) in a space domain (F-X domain).

The wave field is divided into the P-wave and the S-wave and ‘e’ is the input in the following slab. In this case, the P-wave and the S-wave are stored in a separated array in a migration algorithm as wave fields which are separated every depth. The P-wave and the S-wave stored every depth are used as the inputs of imaging condition in migration.

Thus, differently from another migration scheme additionally required to divide the input wave field into the P-wave and the S-wave before migration, such a process may directly use multi-component elastic wave data as the input of migration without any additional mode separation.

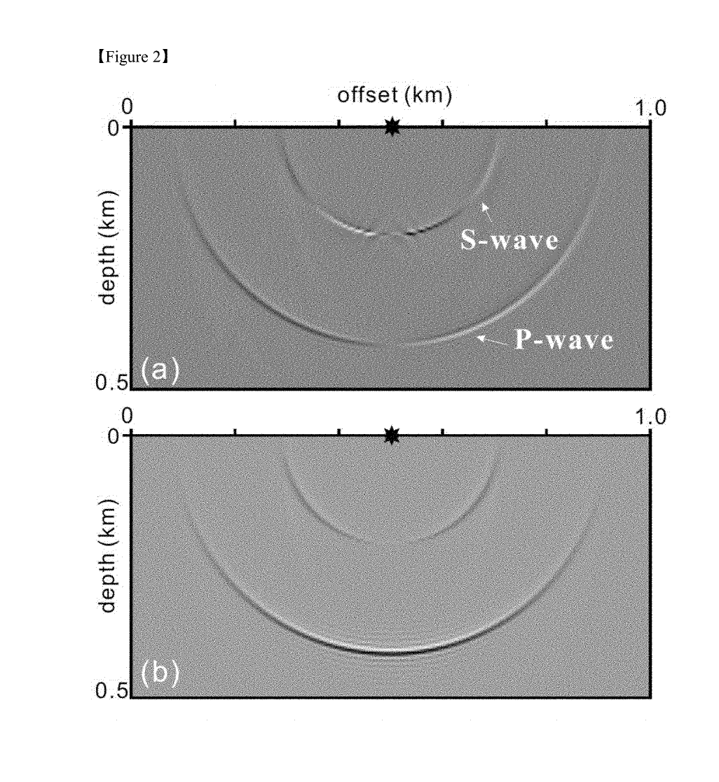

Then, the verification of the impulse response of the EGS wave propagator implemented as described above will be described with reference to FIG. 2.

That is, referring to FIG. 2, FIG. 2 is a view illustrating the wave field propagated through an EGS wave propagator according to an embodiment of the present invention in a zero-perturbation medium.

That is, to verify Equation 17 and the impulse response of the EGS wave propagator implemented as the algorithm illustrated in FIG. 1 according to an embodiment of the present invention, the present inventors have generated a vertical point source on the surface of an isotropic zero-perturbation model, in which any perturbation does not exist and the P-wave speed is 2,100 m/s, the S-wave speed is 1,050 m/s and the density is 2.2 g/cm³, and have shown an impulse response after 0.2 seconds.

In detail, FIG. 2A illustrates the record of horizontal particle velocity field Vx and FIG. 2B illustrates the record of vertical particle velocity field Vz.

In FIG. 2A, in a case of an impulse source, the polarities of the P-wave and the S-wave are changed at the source portion in a horizontal particle speed field. To the contrary, as shown in FIG. 2B, it may be confirmed that the polarities are not changed in a vertical particle speed field.

In addition, when a vertical or horizontal point source is generated in an elastic medium, the P-wave and the S-wave are together generated and the polarities are changed according to the generation directions of the sources and the incident angles. Referring to FIG. 2, it may be confirmed that the polarity of the wave field calculated with the EGS wave propagator is exactly described.

In addition, the present inventors have proposed propagators of each expansion order calculated with the EGS wave propagator implemented in a perturbation existence medium according to an embodiment of the present invention as described above.

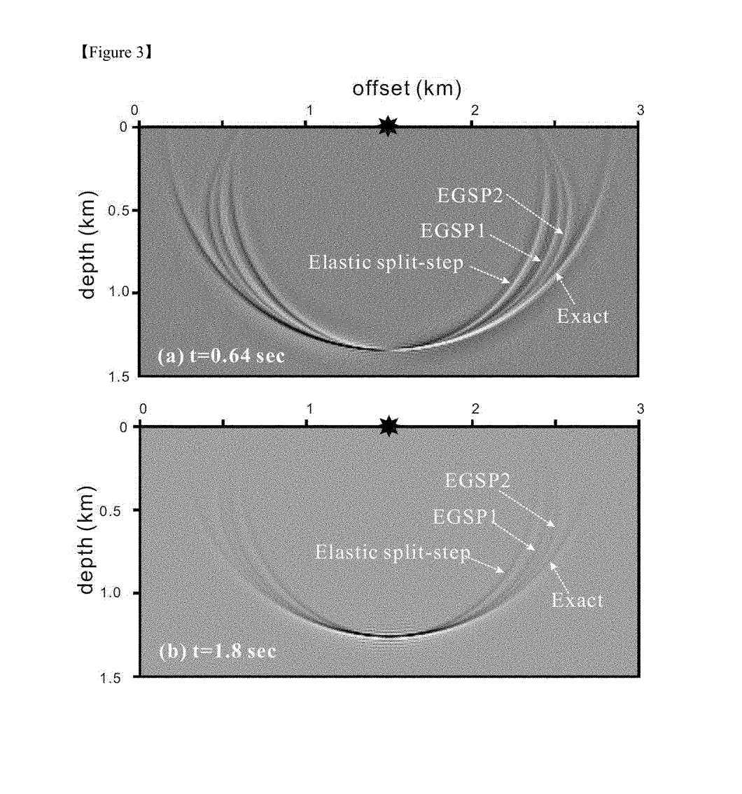

That is, referring to FIG. 3, FIG. 3 is a view illustrating a wave filed propagating to an EGS wave propagator according to an embodiment of the present invention in a perturbation existence medium.

In detail, FIG. 3A illustrates a wave filed of P-wave when a vertical point source is given on a model to which a predetermined perturbation is given. FIG. 3B illustrates a wave filed of S-wave when a vertical point source is given on a model to which a predetermined perturbation is given.

In this case, the wave fields of the P-wave and the S-wave represent wave filed divided into the P-wave and the S-wave by the algorithm [M⁰]⁻¹. In this model, the speeds of the P-wave and the S-wave are 2100 m/s and 700 m/s, respectively and, when the perturbations of the speed and the density are given, the background speeds of the P-wave and the S-wave of a medium are given as ⅔ of the actual speeds to confirm a degree of an approximation of a wave.

In addition, as shown in FIG. 3, the elastic split step shows o (zero)-order expansion, EGSP 1 shows the first order expansion, EGSP2 shows a second-order expansion propagator proposed in the present invention.

That is, as shown in FIG. 3, it may be confirmed that a wave propagates approximately to an actual propagation as the number of expansion orders is increased. It may be confirmed that a second-order propagator is most approximate to an actual wave.

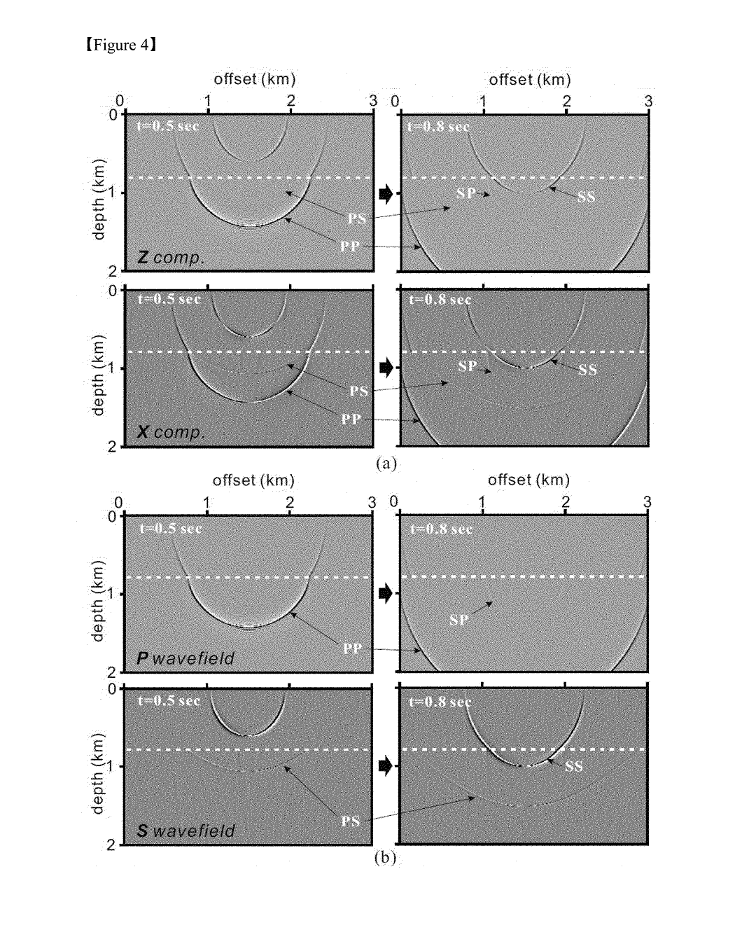

Next, referring to FIG. 4, FIG. 4 is a view illustrating a wave filed of each component propagating through an EGS wave propagator according to an embodiment of the present invention and wave fields divided into the P-wave and the S-wave by a mode separation operator in a simple two-layer horizontal model.

That is, the present inventors have confirmed on the horizontal two-layer model that the wave field is divided into the P-wave and the S-wave by the mode separation operator [M⁰]⁻¹ included in the EGS wave propagator.

In this case, the speed of the P-wave and the speed and density of the S-wave on the upper layer of the used model were 2500 m/s, 1200 m/s and 2.2 g/cm³, and the speed of the P-wave and the speed and density of the S-wave on the lower layer of the used model were 3500 m/s, 1500 m/s and 2.4 g/cm³. The size of the model was 3×2 km, and the depth of the upper layer was 0.8 km.

In addition, as shown in FIG. 4, when the horizontal point source is generated at the point of 1.5 km from the ground surface, the wave field in the vertical particle velocity field and the horizontal particle velocity field is shown in FIG. 4A and the wave field divided into the P-wave and the S-wave is shown in FIG. 4B. In FIG. 4, the left side views are snapshots of the wave field after 0.5 seconds from the time that the source is generated, and the right side views are snapshots of the wave field after 0.8 seconds from the time that the source is generated.

As shown in FIG. 4, it was confirmed that the P-wave and the S-wave coexist and propagate on the vertical particle velocity field (Z-component) and the horizontal particle velocity field (X-component) together with each other. In addition, it was confirmed that the P-wave exists only on the P-wave field and the S-wave exist only on the S-wave field on sections into which the mode is divided by [M⁰]⁻¹ in the EGS wave propagator.

In addition, mode conversion waves generated from the boundary surface, that is, SP and PS may remain only in the P-wave and the S-wave, respectively. In other words, since the P-wave and the S-wave are exactly separated at each propagation step, the wave field propagating into the EGS wave propagator according to the embodiment of the present invention is stored in an additional wave field array to be used for migration, so that P-wave and S-wave migration sections may be finally obtained.

Hereinafter, a method of implementing an S-wave inversion correction and a migration algorithm, to which the image condition is applied, by using the EGS wave propagator according to an embodiment of the present invention described above will be explained.

In general, the wave field generated from the source by the propagator and the wave field generated from the receiver (that is, the input multi-component wave filed used for migration) by the propagator are imaged through cross-correlation or convolution. This means that a final migration section is finally obtained.

In this case, the imaging condition is how to perform the cross-correlation or convolution. In general, if the P-wave and the S-wave are separated from the obtained multi-component elastic wave data, a good result may be obtained through the migration method using an acoustic wave equation under the imaging condition expressed as following Equation 18.

I(x_{μ},x₃)=(±)∫iω\tilde{μ}_{S}(x_{μ},x₃,ω)ũ*_{R}(x_{μ},x₃,ω)dω [Equation 18]

Wherein [symbol] represents a scalar source wave field in the Fourier domain, [symbol] represents a scalar receiver wave field in the Fourier domain, symbol ‘*’ represents a complex conjugate.

In addition, when the multi-component data are applied to Equation 18, the P-wave is generated from the source wave field. When the S-wave field perfectly separated from the multi-component input data is input to the receiver wave field, a PS image may be finally obtained.

However, it is difficult to separate the P-wave and the S-wave from the multi-component data collected from an actual working field. If the imaging condition of Equation 18 is used by using the inexactly separated P-wave and S-wave, a distortion is generated in an image.

To the contrary, according to the EGS migration method of an embodiment of the present invention, since the P-wave and the S-wave are separated by the mode separation operator [M⁰]⁻¹ in the EGS wave operator at the propagation step and is separately stored, when the P-wave and the S-wave separated as described above are applied to the imaging condition such as Equation 18, a good result may be obtained.

In addition, since the mode separation and imaging are performed in the frequency-space domain, a high quality of an image, which is free from aliasing or noise which may be generated due to the numerical FFT, may be obtained without requiring any additional Fourier transforms.

To this end, the EGS migration algorithm according to an embodiment of the present invention does not use Equation 18 as it is, but uses an imaging condition expressed as Equation 19 by applying a stabilized division method proposed by Schleicher et al. (2008, reference document 15) for more stable imaging.

$${I}_{ij} ( {x}_{μ} , z ) = ( \pm ) \int \frac{i ω {\tilde{u}}_{S , i} ( {x}_{μ} , z ; ω ) {\tilde{u}}_{R , j} ⋆ ( {x}_{μ} , z ; ω )}{i ω {\tilde{u}}_{R , i} ( {x}_{μ} , z ; ω ) {\tilde{u}}_{R , j} ⋆ ( {x}_{μ} , z ; ω ) + ɛ} d ω \qquad [ Equation 19 ]$$

Wherein ε existing in the denominator, which is a value obtained by applying a scaling fraction (0<λ<1) to the square of the absolute value of the receiver wave field, may be expressed as ε(ω,z)=λ[max(|u_{R}(x_{μ},z;ω)|²)], and ‘i’ and ‘j’ represent a source and a vector wave field of a receiver (that is, the horizontal component (x-component) and the vertical component (z-component) in the multi-component elastic wave data).

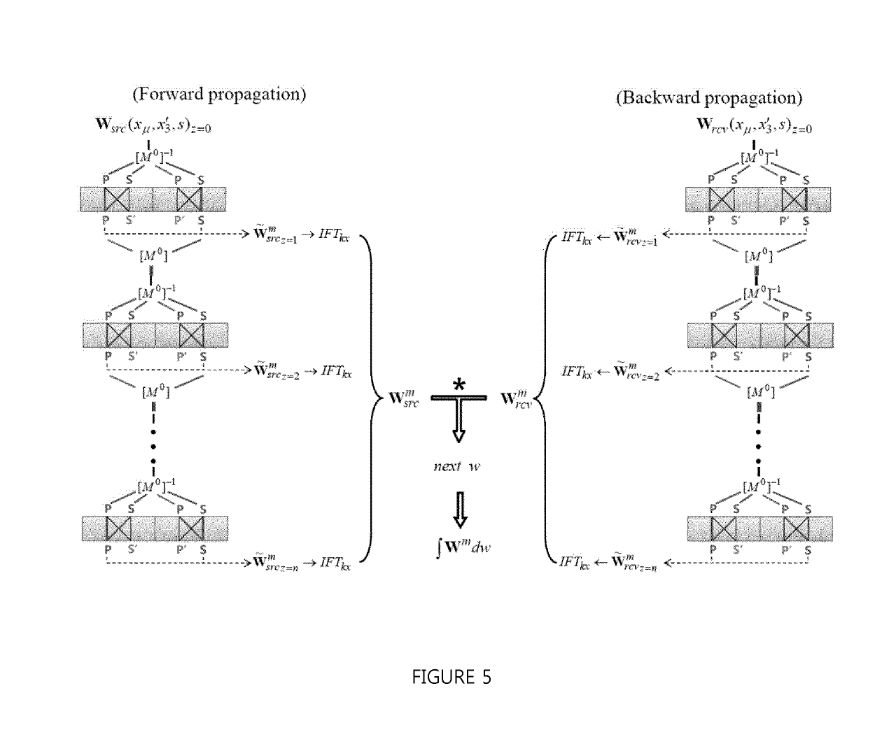

That is, referring to FIG. 5, FIG. 5 is a view illustrating a concept of an EGS migration algorithm using an EGS wave propagator shown in FIG. 1.

In detail, the concept view of the EGS migration algorithm shown in FIG. 5 is a case that the thin slab propagation described with reference to FIG. 1 is expanded to the entire model. In FIG. 5, a forward propagation represents a wave field propagation in a source and a backward propagation represents a wave field propagation in a receiver.

As shown in FIG. 5, the mode separation and the mode coupling are performed before and after the thin slab, and the separated P-wave and S-wave from the mode are stored in the separated array and finally used for the imaging condition.

In addition, symbol ‘*’ of FIG. 5 represents cross correlation, where Equation 19 is used as the imaging condition.

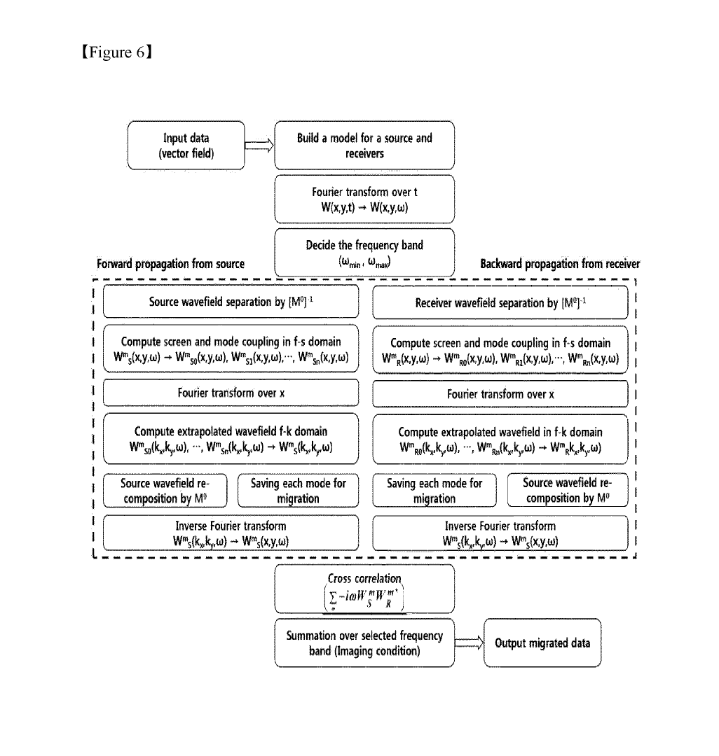

In addition, referring to FIG. 6, FIG. 6 is a flowchart illustrating the entire configuration of an EGS migration algorithm according to an embodiment of the present invention implemented based on the concept shown in FIG. 5.

As shown in FIG. 6, a migration algorithm according to an embodiment of the present invention may mainly include the steps of: establishing a model for a source and a receiver after receiving elastic wave multi-component data to be analyzed and determining a frequency band to be calculated through Fourier transform; calculating a forward propagation from the source over each frequency band by using the EGS wave propagator and a backward propagation from the receiver over each frequency band by using the EGS wave propagator, respectively; integrating the forward propagator with the backward propagator through cross correlation and migrating image data under an imaging condition; and outputting the migrated image data.

In this case, the step of calculating the source wave field in the source may include the steps of: separating a source wave field by a mode separation operator [M⁰]⁻¹ in the EGS wave propagator; calculating a screen and a mode coupling in the f-x domain; Fourier-transforming the screen and the mode coupling with a spatial variable x; calculating an extrapolated wave field in the f-k domain; storing each mode for the migration and recomposing the source wave field using a mode coupling operator M⁰ in the EGS wave operator; and inversion-Fourier-transforming the recomposed source wave field.

Likewise, the step of calculating the backward propagation from the receiver may include the steps of: separating a receiver wave field using a mode separation operator [M⁰]⁻¹ in the EGS wave propagator; calculating the screen and the mode coupling in the f-x domain; after Fourier-transforming the screen and the mode coupling calculated with the spatial variable x; calculating the extrapolated wave field in the f-k domain; storing each mode for the migration and recomposing the receiver wave field using the mode coupling operator M⁰ in the EGS wave operator; and inversion-Fourier-transforming the recomposed receiver wave field.

In addition, the EGS wave propagator may be obtained as described above with reference to Equation 1 to Equation 17.

In addition, the imaging condition may be obtained as described above with reference to Equation 18 and Equation 19.

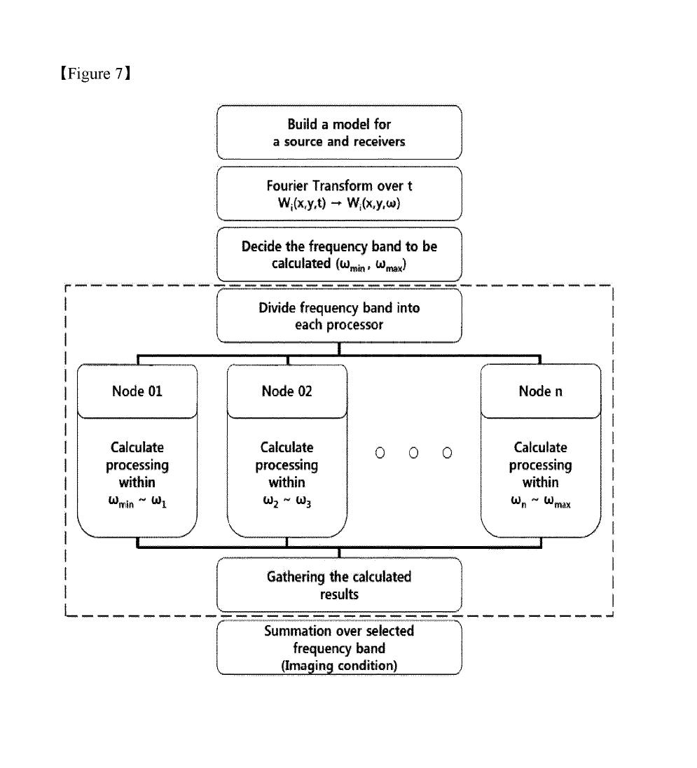

In addition, in FIG. 6, each code may be optimized with a message passing interface (MPI) code to be parallel-processed. A flowchart for MPI may be configured as shown in FIG. 7.

That is, referring to FIG. 7, FIG. 7 is a flowchart schematically illustrating the entire configuration of a process of implementing MPI for a parallel processing of the EGS migration algorithm according to an embodiment of the present invention shown in FIG. 6.

As shown in FIG. 7, the processes may be processed in parallel by being assigned to a plurality of processors according to each frequency band to reduce the entire processing time.

In this case, the S-wave propagates through a medium so that the polarity of the S-wave is changed at the reflection point of a medium boundary surface. Although most of the elastic migration schemes according to the related art must separate the S-wave polarity inversion phenomenon from the spatial domain, in a case that the reflection surface is not level but has a complex actual underground structure, it has been difficult to investigate where the reflection point is.

However, the EGS method according to an embodiment of the present invention may correct the polarity inversion phenomenon in the frequency-wavenumber domain because of the property of the propagator calculation.

In more detail, by Sava and Fomel. (2003, reference document 14), the reflection angle at the reflection point in the wavenumber domain may be obtained through following Equation 20.

$$tan γ = - \frac{{k}_{h}}{{k}_{z}} \qquad [ Equation 20 ]$$

Wherein γ represents a reflection angle at a reflection point, and kₕ and k_{z} represent a wavenumber in a distance direction and a wavenumber in a depth direction, respectively.

According to Equation 20, the sign of the reflection angle at the reflection point may be expressed as −1×sign of horizontal wavenumber. Thus, the polarity of the S-wave is obtained only by changing the sign of one side into the inverse sign thereof based on the point of kₓ=0 in the frequency-wavenumber domain.

That is, referring to FIG. 8, there is shown the migration results obtained with and without a correction method of a polarity inversion by using the imaging condition expressed as Equation 20.

In FIG. 8, FIG. 8A illustrates a result of performing a migration through an EGS migration method according to an embodiment of the present invention by using synthetic seismic data generated from one source in a simple two-layer model, FIG. 8B illustrates a PP section, FIG. 8C illustrates a PS section in which a polarity inversion phenomenon is not corrected, and FIG. 8D illustrates a PS section in which a polarity inversion phenomenon is corrected by using Equation 20.

Therefore, as shown in FIG. 8, it may be confirmed in FIG. 8C that the polarity of PS is changed at a reflection point, and it may be confirmed in FIG. 8D illustrating the correction section that any inversion phenomena do not exist.

Next, the result of verification by applying an EGS migration method according to an embodiment of the present invention, which is implemented as described above, to an actual model will be described.

That is, the inventors confirmed that an actual model is well matched with the image obtained through migration by the EGS migration method to a more realistic and complex model. To this end, in SEG/EAGE Salt Model (Aminzadeh et al., 1997, see reference document 16) which is well known as a benchmark model in an elastic wave prospecting field, a multi-component elastic wave data were artificially generated through a numerical modeling and a migration section was obtained by applying the EGS migration method according to an embodiment of the present invention by using the multi-component elastic wave data.

In this case, although the SEG/EAGE Salt model is a three-dimensional model to, a two-dimensional section model corresponding to a part of x=7680 m was extracted to generate data through a two-dimensional modeling.

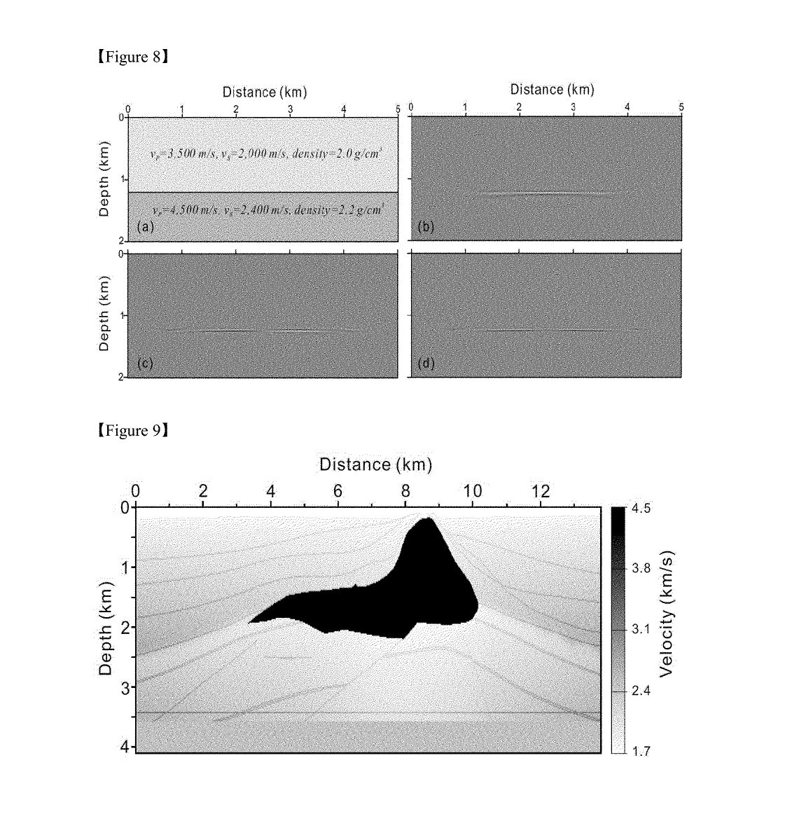

That is, FIG. 9 is a view illustrating a P-wave speed configuration of a two-dimensional section model generated as described above.

In FIG. 9, the S-wave speed structure was generated by multiplying the P-wave speed by 1/\sqrt{3} in a lump, and the density model was obtained by using Gardner's equation.

In addition, sources were installed in an area of 760˜12760 m on the ground surface by an interval of 40 m and receivers were installed in an area of 60˜13460 m by an interval of 20 m, such that the synthetic elastic wave data were obtained. In this case, the main frequency was 5 Hz and the maximum frequency was 12.5 Hz.

In addition, a grid interval for migration was set as dx=20 m and dz=10 m in consideration of the minimum speed of the S-wave and the migration is performed in a frequency range of 0˜12 Hz to obtain the final PP and PS sections.

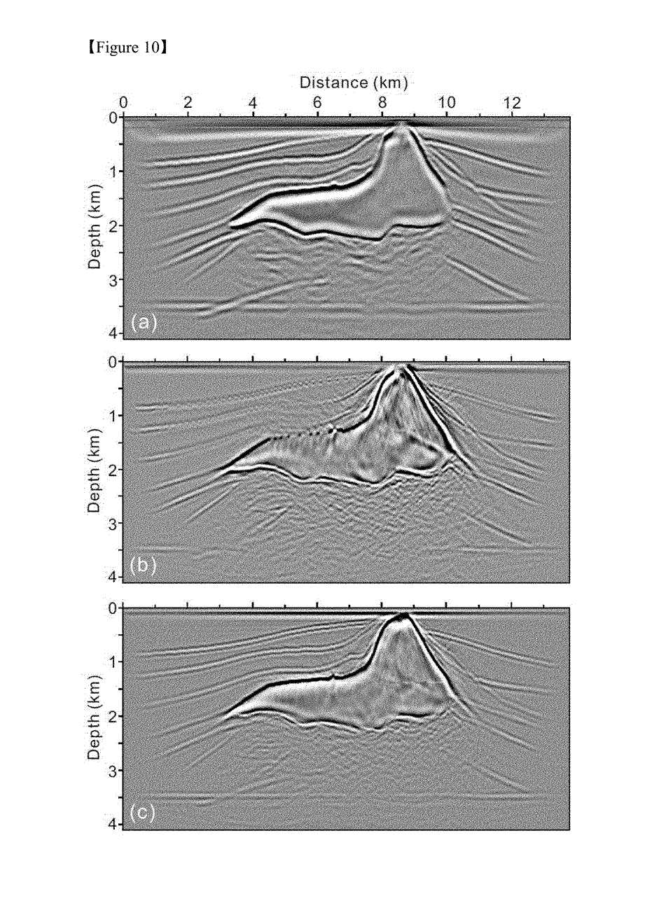

That is, referring to FIG. 10, FIG. 10 is a view illustrating images of final PP and PS sections obtained by applying an EGS migration method according to an embodiment of the present invention.

In FIG. 10, FIG. 10A illustrates a PP migration result. It was confirmed that the image of a salt dome is very exactly expressed as compared with the speed image of FIG. 9 and the circumference reflection boundary surface is imaged at an exact position.

In addition, FIG. 10B illustrates a PS result of executing migration without correcting an S-wave polarity inversion phenomenon, and FIG. 10C illustrates a PS result of using a polarity inversion correction module included in the EGS migration algorithm according to an embodiment of the present invention.

As shown in FIG. 10B, when the polarity inversion phenomenon was not corrected, the quality of an image was deteriorated. Specifically, an event on an upper portion of rock salt was shown in not a smooth line but a dot type. In addition, a level event horizontally elongated on a lower portion of rock salt was not well shown in the result of non-correction of polarity inversion.

That is, in the case that the S-wave polarity inversion phenomenon is not corrected, as compared with the original speed model shown in FIG. 9, the continuity of images was deteriorated and the level layer of a lower portion of rock salt was not completely seen. The reason is because the portions at which the polarities are inversed are offset during the integrating (or adding) process after the mitigating of each shot gather, so that the quality of the image was deteriorated.

To the contrary, as shown in FIG. 10C, as the migration result of correcting the S-wave polarity inversion phenomenon through the polarity inversion correction module included in the EGS migration algorithm according to an embodiment of the present invention, when compared with the original speed model of FIG. 9 and the PP result of FIG. 10A, it was confirmed that the salt body is exactly imaged and the reflection events near it are imaged at comparatively exact positions.

As described above, as compared with the methods according to the related art, the EGS wave propagator and the EGS migration method using the same according to the embodiment of the present invention can perform more exact and realistic migration and imaging so that the quality of an image can be improved.

Therefore, as described above, the prestack EGS migration method for elastic wave multi-component data according to the present invention may be implemented.

In addition, the prestack EGS migration method for elastic wave multi-component data of the present invention may more accurately implement the propagation of a wave even in a model having a complex structure or a great horizontal speed change by expanding a vertical slowness term to the second order, so that the performance of the EGS wave propagator may be more improved, so that the problem of the EGS wave propagator according to the related art that is limited to the approximation of the vertical slowness operator to the first order may be solved.

In addition, according to the present invention, the sections of P-wave and S wave images may be generated by directly using a shot gather as a migration input without any needs to divide an input multi-component wave field into the P-wave and the S-wave, by including a P-S separation module implemented in an EGS wave propagator, thereby solving the problem of the migration method according to the related art, in which the calculation and structure are complex because the wave field is divided into the P-wave and S-wave and used as an input before migration.

In addition, according to the present invention, the quality of an S-wave migration image may be improved by adding a module for correcting polarity conversion in a wavenumber-frequency domain before S-wave is imaged, so that the problem of the related art that the continuity of events due to the phenomenon that the polarity of the S-wave shot gather is reversed at a reflection point when the S-wave shot gather of an elastic wave itself is used to correct the migration, thereby deteriorating the quality of a final section may be solved.

Hereinabove, the exemplary embodiments of the present invention describe in detail the prestack EGS migration method for elastic wave multi-component data, but the present invention is not limited to the contents of the foregoing exemplary embodiments and therefore the present invention may be variously modified, changed, combined, and replaced according to a necessity of design and other various factors by a person having ordinary skill in the art to which the present invention pertains.

1. A prestack EGS migration method for elastic wave multi-component data, which expresses a movement of an elastic wave passing through a mutual mode conversion between a P-wave and an S-wave while propagating boundary surfaces of an underground medium, and generates sections of P-wave and S wave images by directly using a shot gather as a migration input without any needs to divide input data into the P-wave and the S-wave, by expanding a vertical slowness term of an elastic generalized-screen (EGS) wave propagator to a second order when multi-component data are migrated, the prestack EGS migration method comprising:
establishing a model for a source and a receiver after receiving elastic wave multi-component data to be analyzed and determining a frequency band to be calculated through Fourier transform;
calculating a forward propagation from the source over each frequency band by using the EGS wave propagator;
calculating a backward propagation from the receiver over each frequency band by using the EGS wave propagator;
integrating the forward propagator with the backward propagator through cross correlation and migrating image data under an imaging condition; and
outputting the migrated image data.

2. The prestack EGS migration method of claim 1, wherein the EGS wave propagator is expressed as a following equation:
$$\int {dx}_{1}^{′} {dx}_{2}^{′} {g}_{OSP}^{( \pm )} ( {x}_{μ} , {x}_{3} \text{:} {x}_{y}^{′} , {x}_{3}^{′} - Δ {x}_{3} ) ( \text{?} ) = \int {( \frac{s}{2 π} )}^{2} d {α}_{1}^{″} d {α}_{2}^{″} exp [ - {isa}_{σ}^{″} {x}_{σ} ] {M}^{0} ( {\overline{x}}_{3} , {α}_{v}^{″} ) exp [ ∓ s Δ {x}_{3} {π}^{0} ( {\overline{x}}_{3} , {α}_{v}^{″} ] \times N \{ \int {dx}_{1}^{′} {dx}_{2}^{′} exp [ {isa}_{σ}^{″} {x}_{σ}^{′} ] {exp [ ∓ s Δ {x}_{3} π \text{?} ( {x}_{μ}^{′} , {\overline{x}}_{3} , 0 ) ] [ {M}^{0} ]}^{- 1} ( {\overline{x}}_{3} , {α}_{v}^{″} \} ) ( \text{?} ) \times ( ∓ ) s Δ {x}_{3} {\sum }_{n} {\sum }_{λ} {\sum }_{i , j , k = 1}^{n} ( ( {ϕ}_{ik} ) \text{?} ( {\overline{x}}_{3} , {α}_{v}^{″} ) - ( {ϕ}_{ik} ) \text{?} ( {\overline{x}}_{3} , 0 ) \} \times \int {dx}_{1}^{′} {dx}_{2}^{′} exp [ {isa}_{σ}^{″} {x}_{σ}^{′} ] exp [ ∓ s Δ {x}_{3} {π}_{r}^{1} ( {x}_{μ}^{′} , {α}_{v}^{″} ) - ( {ϕ}_{ik} ) \text{?} ( {\overline{x}}_{3} , 0 ) ] ( {ξ}_{ik} ) \text{?} {( {x}_{μ} , {\overline{x}}_{3} ) [ {M}_{kj}^{0} ]}^{- 1} ( {\overline{x}}_{3} , {α}_{v}^{″} ) ( \text{?} \} \\ \text{?} \text{indicates text missing or illegible when filed}$$
wherein x_{μ} (μ=1, 2) and x₃ represent horizontal and vertical coordinates, s=−iω (ω is an angular frequency), αᵥ=kᵥ/iω (kᵥ is a horizontal component wavenumber, v=1, 2), exp[−isα″_{σ}x_{σ}] and exp[isα″_{σ}x′_{σ}] are Fourier transform and Fourier inverse transform, M⁰ is a diversification matrix including an eigenvector and serves as an operator for coupling a P-wave and an S-wave separated from each other, [M⁰]⁻¹ is an inverse matrix of M⁰ and serves as an operator for separating the P-wave and the S-wave from each other, and λ is a number of terms.

3. The prestack EGS migration method of claim 2, wherein the calculating of the forward propagation comprises:
separating a source wave field by a mode separation operator ([M⁰]⁻¹) in the EGS wave propagator;
calculating a screen and a mode coupling in a frequency-space (f-x) domain;
Fourier-transforming the screen and the mode coupling with a spatial variable (x);
calculating an extrapolated wave field in a frequency-wavenumber (f-k) domain;
storing each mode for the migration and recomposing the source wave field using a mode coupling operator (M⁰) in the EGS wave operator; and
inversion-Fourier-transforming the recomposed source wave field.

4. The prestack EGS migration method of claim 3, wherein the calculating of the backward propagation comprises:
separating a receiver wave field using a mode separation operator ([M⁰]⁻¹) in the EGS wave propagator;
calculating the screen and the mode coupling in the frequency-space domain;
Fourier-transforming the screen and the mode coupling calculated with the spatial variable (x);
calculating the extrapolated wave field in the frequency-wavenumber domain (f-k);
storing each mode for the migration and recomposing the receiver wave field using the mode coupling operator (M⁰) in the EGS wave operator; and
inversion-Fourier-transforming the recomposed receiver wave field.

5. The prestack EGS migration method of claim 4, wherein the calculating of the forward propagation and the calculating of the backward propagation are parallel processed by assigning a plurality of processors to process the calculation over frequency bands, thereby reducing a total processing time.

6. The prestack EGS migration method of claim 5, wherein the migrating of the image data uses the imaging condition expressed as a following equation:
$${I}_{ij} ( {x}_{μ} , z ) = ( \pm ) \int \frac{i ω {\tilde{u}}_{S , i} ( {x}_{μ} , z ; ω ) {\tilde{u}}_{R , j} ⋆ ( {x}_{μ} , z ; ω )}{i ω {\tilde{u}}_{R , i} ( {x}_{μ} , z ; ω ) {\tilde{u}}_{R , j} ⋆ ( {x}_{μ} , z ; ω ) + ɛ} d ω$$
wherein Iᵢⱼ is a final image, [symbol] is a scalar source wave field in a Fourier domain, [symbol] is a scalar receiver wave field in the Fourier domain, ‘ε’ is expressed as ε(ω,z)=λ[max(|u_{R}(x_{μ},z;ω)|²], ‘i’ and ‘j’ are vector wave fields of the source and the receiver and represent horizontal and vertical components (x and z) in multi-component elastic wave data.

7. The prestack EGS migration method of claim 6, further comprising correcting an S-wave polarity inversion phenomenon that represents a change of a polarity at a reflection point of a medium boundary surface, by obtaining a reflection angle at the reflection point in the frequency-wavenumber domain by using a following equation:
$$tan γ = - \frac{{k}_{h}}{{k}_{z}}$$
wherein γ represents a reflection angle at a reflection point, and kₕ and k_{z} represent a wavenumber in a distance direction and a wavenumber in a depth direction, respectively.

8. A prestack EGS migration system for elastic wave multi-component data using the prestack EGS migration method for elastic wave multi-component data of claim 1, wherein the prestack EGS migration system generates sections of P-wave and S wave images by directly using a shot gather as a migration input without any needs to divide an input multi-component wave field into the P-wave and the S-wave, and improves a quality of an S-wave migration image by correcting polarity conversion in a wavenumber-frequency domain before S-wave is imaged.
